(19) United States
(12) Patent Application Publication
(10) Pub. No.: US 2006/0169524 A1
(43) Pub. Date: Aug. 3, 2006

(54) Steering-column assembly

(75) Inventors: Christian Born, Hamburg (DE); Hans-Joachim Hurschler, Ellerbek (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/539,607

(22) PCT Filed: Nov. 13, 2003
(86) PCT No.: PCT/EP03/12684

§ 371 Date: Jan. 17, 2006

(30) Foreign Application Priority Data
Dec. 19, 2002 (DE) 102 59 596.8

(51) Int. Cl. B62D 5/04; B62D 1/19

(52) U.S. Cl. 180/444; 280/777

(57) ABSTRACT

The invention relates to a steering-column assembly 1, in which the telescopic spindle 5.1 is fastened to the inner casing tube 2.1 via a crash element 4. The telescopic spindle 5.1 moves into the crash element 4 by virtue of the fact that the spindle nut 5.6 is fixed to the crash element 4, which permits reduced installation space for the telescopic spindle 5.1. In order to improve acoustic decoupling, the spindle nut 5.6 is composed at least partially of plastic. By mechanical decoupling of the tensile and compressive forces of the telescopic spindle 5.1 from the torque which acts on the telescopic spindle 5.1, the possibility is provided of using plastic for a drive shaft 5.4 of the telescopic spindle 5.1 and for the bearings 5.7, 5.7′ of the telescopic drive 5.3.

### BACKGROUND AND SUMMARY OF THE INVENTION

The invention relates to a steering-column assembly for a motor vehicle, having an outer casing tube, a telescopic inner casing tube and a telescopic drive having a spindle nut, a telescopic spindle which is fastened to the inner casing tube via a crash element, and a telescopic motor having a step-down gear mechanism.

DE 198 12 179 C1has already disclosed a steering-column assembly for a motor vehicle, having an outer casing tube which is arranged in a fixed position, and having an inner casing tube which can be displaced telescopically in the outer casing tube, and having an adjusting apparatus which acts between the two casing tubes in order to displace the inner casing tube. The steering-column assembly has an actuator which acts on the inner casing tube, extends longitudinally and is oriented axially parallel to the longitudinal axis, the actuator being assigned energy absorption means.

The invention is based on the object of configuring and arranging a steering-column assembly in such a way that the amount of crash energy which can be absorbed is increased, the steering-column assembly is acoustically decoupled from the vehicle body, and the installation space is reduced.

According to the invention, the object is achieved by the fact that the crash element is of at least partially hollow configuration and accommodates the spindle nut.

The result of this is that the telescopic spindle moves into the crash element during rotation and the installation space in the movement direction of the spindle behind the spindle nut is thus reduced.

As a result of the fact that the spindle nut is arranged in the crash element, a solution for rotation of the telescopic spindle is provided which, compared with the conventional drive of a spindle nut, forms a simple drive, as the telescopic spindle is driven via one of its end sides. The relatively simple drive of the telescopic spindle provides the possibility of acoustically decoupling the telescopic drive, which will be explained in the following text.

It is advantageous that the crash element is formed by a sleeve and a pin which is positioned coaxially with respect to the sleeve, is at least partially inserted into the sleeve at one end side of the sleeve and is fastened to the sleeve. This construction makes it possible to accommodate the spindle nut and has the property that, in the event of a collision, the crash element collapses into itself and absorbs a portion of the crash energy which acts on the steering-column assembly, or converts it into thermal and deformation energy.

The crash element which in practice extends the telescopic spindle is formed by a material which is simple compared with the spindle. The manufacture of the telescopic spindle does not require thermal treatment or any other treatment which is required for spindles.

According to one development, a further possibility is that the telescopic spindle is connected via a flexible drive shaft to an output shaft of the step-down gear mechanism, the opposite side of the telescopic spindle from the spindle nut being mounted rotatably in a bearing block which is structurally separate from the step-down gear mechanism.

The solution of a simple drive of the telescopic spindle, which is described in the introduction, makes it possible firstly to mechanically and thus acoustically decouple the steering-column assembly. Most of the noise during displacement of the steering-column assembly is transmitted by structure-borne sound. The assembly can be acoustically decoupled by introducing a flexible drive shaft as intermediate shaft between the telescopic spindle and the output shaft of the step-down gear mechanism. The substantial part of the structure-borne sound is formed by the drive unit, comprising the motor and step-down gear mechanism.

Polymer plastic or rubber is used for acoustic decoupling. However, the use of plastic assumes mechanical decoupling, because the operational loading is too high for plastic bearings and shafts. The problem of mechanical decoupling is solved by the bearing block which is fastened to the body of the motor vehicle or to the outer casing tube.

For this purpose, it is advantageous for the tensile and compressive forces which are produced during telescoping of the steering spindle in the direction of a longitudinal axis of the telescopic spindle to be passed directly from the telescopic spindle to a part of the vehicle body via the bearing block. The tensile and compressive forces are mechanically decoupled from the drive of the telescopic spindle, that is to say from the step-down gear mechanism and the drive unit. There is no need for mounting of the drive unit to be dimensioned in accordance with the tensile and compressive loading. The drive unit is substantially quieter as a result of the fact that the drive unit has to absorb only a torque for rotating the telescopic spindle.

According to one preferred embodiment of the solution according to the invention, there is provision finally for it to be possible for the outer casing tube to be pivotable about a y-axis by a pivot drive which has a spindle nut, a spindle and a flexible drive shaft, the spindle being connected via the flexible drive shaft to an output shaft of a step-down gear mechanism, and the opposite side of the spindle from the spindle nut being mounted rotatably in a bearing block which is structurally separate from the step-down gear mechanism. A second motor which drives the step-down gear mechanism is provided as a pivoting motor.

The solution which is used with regard to the telescopic spindle affords the additional advantage, for pivoting the outer casing tube, that the flexible drive shaft for transmitting a torque can also be bent or curved. The spindle is also pivoted by virtue of the drive unit being fixed to the vehicle body.

For this purpose, it is advantageous that the longitudinal axis of the spindle and the rotational axis of the output shaft of the step-down gear mechanism, which output shaft is connected directly to the flexible drive shaft, enclose an angle between 135° and 180°. Depending on the pivoting range of the outer casing tube, the drive shaft for transmitting a torque is of correspondingly flexible configuration. The flexible drive shafts within the steering-column assembly differ with regard to their lengths and with regard to their torsional properties, because the torques which are to be transmitted for telescoping or pivoting are of different magnitude.

With regard to the pivoting arrangement, it is advantageous that the tensile and compressive forces which are produced during pivoting of the outer casing tube in the direction of a longitudinal axis of the spindle are passed directly from the spindle to a part of the vehicle body via the bearing block. As with regard to the telescoping, the end result is that the telescopic motor and the step-down gear mechanism are partially mechanically decoupled from the telescopic spindle and are loaded only by a torque.

In conjunction with the configuration and arrangement according to the invention, it is of advantage that the spindle nut which engages with the telescopic spindle or with the spindle and the flexible drive shaft which is connected to the telescopic spindle or the spindle are formed at least partially from plastic.

As a result of the partial mechanical decoupling of the drive unit, the flexible drive shaft which is formed as an intermediate shaft for the pure transmission of a torque is formed at least partially from plastic or from another material which is advantageous with regard to acoustic decoupling. A very good solution principle is found in the area of components which are formed from a plurality of different materials.

The flexibility of the drive shaft is increased by the plastic and, above all, the transmission of vibrations and thus the development of noise are reduced. This also advantageously has an effect in a spindle nut which is formed from plastic and additionally has improved self-lubrication properties.

Furthermore, it is advantageous that the flexible drive shaft is mounted in the bearing block in a manner which is connected on the output side to the telescopic spindle or to the spindle, and is mounted in the step-down gear mechanism in a manner which is connected on the input side to the output shaft. The remaining part of the flexible drive shaft lies free, in order that bending is made possible without disturbances. In addition, the bearings of the flexible drive shaft within the step-down gear mechanism and within the bearing block are lubricated and sealed appropriately with regard to the rest of the drive shaft. The bearings of the flexible drive shaft are made from metal and are fastened as a conventional shaft end to the plastic regions.

Moreover, it is advantageous that the step-down gear mechanism and/or the motor are/is mounted on the vehicle body by a bearing which is formed at least partially from plastic. Not only the flexible drive shaft but also the bearing of the drive unit therefore contribute to the acoustic decoupling with regard to the vehicle body. The structure-borne sound which is still passed into the drive unit, that is to say into the step-down gear mechanism and into the motor, despite the flexible drive shaft is dissipated or damped by the plastic bearings.

The conversion of a rotational movement into a translatory movement on the input side by decoupling the tensile and compressive forces from the torques forms the basis for the acoustic decoupling with the aid of plastic and the reduction of the installation space for the spindles.

Further advantages and details of the invention are explained in the patent claims and in the description, and are shown in the figures.

### BRIEF DESCRIPTION OF THE DRAWINGS

FIG. 1 shows a perspective view of a steering-column assembly; and

FIG. 2 shows a sectional view of a crash element.

### DETAILED DESCRIPTION OF THE DRAWINGS

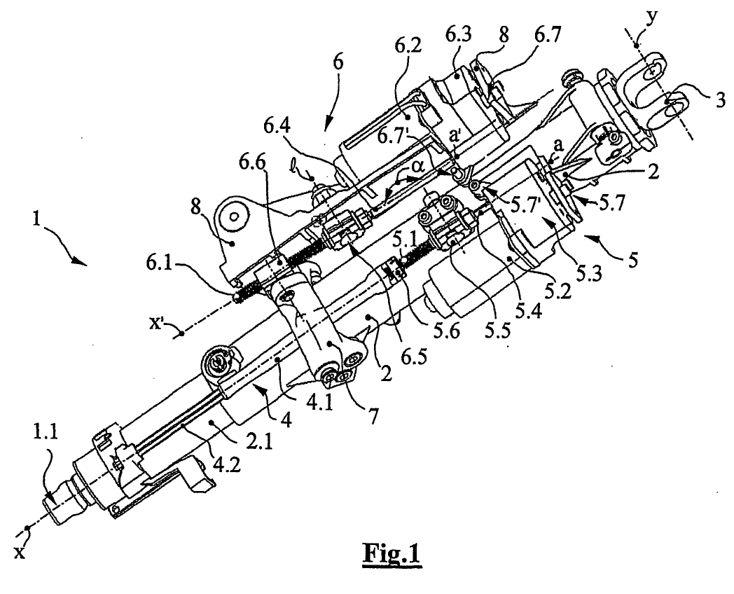

FIG. 1 shows a perspective view of a steering-column assembly 1. The head 1.1 is adjoined by a steering wheel (not shown). The right-hand side is adjoined by a steering mechanism (not shown).

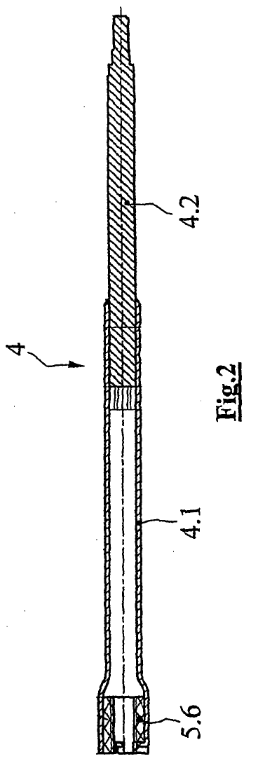

An inner casing tube 2.1 transmits the rotational movement from the steering wheel to an outer casing tube 2 which adjoins the steering mechanism by way of a claw 3. The inner casing tube 2.1 can be telescoped or displaced into the outer casing tube 2. For this purpose, a crash element 4 is attached to the inner casing tube 2.1. In accordance with FIG. 2, the crash element 4 has a sleeve 4.1 and a pin 4.2. The pin 4.2 is inserted into the sleeve 4.1 and is connected to the latter by a clamping connection.

The crash element 4 is fastened to the inner casing tube 2.1 using the pin 4.2. A spindle nut 5.6 is introduced into the sleeve 4.1 on the opposite side of the crash element 4. One side of the telescopic spindle 5.1 reaches into the spindle nut 5.6. The opposite side of the telescopic spindle 5.1 is mounted rotatably in a bearing block 5.5. The crash element 4 and thus the inner casing tube 2.1 is moved in the direction of the longitudinal axis x by rotating the telescopic spindle 5.1. The steering-column assembly 1 is thus telescoped.

The telescopic spindle 5.1 is fixed in position by the bearing block 5.5, above all, in the direction of the longitudinal axis x. The bearing block 5.5 is fastened to a bracket 8 which transmits the bearing forces to a part of the vehicle body.

The telescopic spindle 5.1 is driven by a flexible drive shaft 5.4, with which the telescopic spindle 5.1 is operatively connected within the bearing block 5.5. The flexible drive shaft 5.4 transmits a drive moment from a drive unit. The drive unit is formed from a telescopic motor 5.2 and a step-down gear mechanism 5.3. An output shaft (not visible) having a rotational axis a is arranged within the step-down gear mechanism 5.3. The output shaft is connected directly to the flexible drive shaft 5.4.

The drive unit or the step-down gear mechanism 5.3 is mounted on the outer casing tube 2 via a plurality of bearings 5.7, 5.7′. The flexible drive shaft 5.4 transmits only a torque, as a result of the mechanical decoupling of the tensile and compressive forces from the drive unit. As a result, it is possible to configure the flexible drive shaft 5.4 at least partially from plastic and thus also to acoustically decouple the drive unit. In order to enhance the acoustic decoupling, the spindle nut 5.6 and the bearings 5.7, 5.7′ are additionally formed from plastic.

In addition to the ability of the inner casing tube 2.1 to telescope, the outer casing tube 2 is mounted via a claw 3 so as to be pivotable about a y-axis. Lever kinematics 7 are attached to the outer casing tube 2 for pivoting purposes, the said lever kinematics 7 accommodating a spindle nut 6.6. A spindle 6.1 engages into the spindle nut 6.6, which spindle 6.1 is mounted so as to be rotatable in the direction of the longitudinal axis x′ with respect to the spindle nut 6.6, in a bearing block 6.5 perpendicularly with respect to the longitudinal axis x′. In turn, the bearing block 6.5 is mounted rotatably on the bracket 8. When the outer casing tube 2 pivots, the spindle 6.1 pivots about the bearing axis 1 of the bearing block 6.5.

The spindle 6.1 is driven via a flexible drive shaft 6.4 which is in turn driven by an output shaft (not visible) of a step-down gear mechanism 6.3. The flexible drive shaft 6.4 is bent as the outer casing tube 2 is pivoted. Here, the longitudinal axis x′ of the spindle 6.1 encloses an angle α of 135° with the rotational axis a′ of the output shaft.

The drive unit which comprises the pivoting motor 6.2 and the step-down gear mechanism 6.3 is mechanically decoupled by this arrangement of the pivot drive 6 by the tensile and compressive forces which act in the direction of the longitudinal axis x′. Here, the flexible drive shaft 6.4 which is formed partially from plastic acts as an acoustic decoupling means. The acoustic decoupling is enhanced by the fact that the bearings 6.7, 6.7′ of the drive unit and the spindle nut 6.6 are also formed from plastic.

The flexible drive shaft 5.4 is likewise bent during pivoting of the outer casing tube 2 as a result of the articulation of the bearing block 5.5 for the telescopic spindle 5.1 on the bracket 8. The use of a flexible drive shaft 5.4, 6.4 is made possible by the mechanical decoupling of the tensile and compressive forces.

The decoupling of the tensile and compressive forces from the torques is made possible by fixing the spindle nuts 5.6, 6.6 and rotating the spindles 5.1, 6.1.

1. A steering-column assembly for a motor vehicle, having an outer casing tube, a telescopic inner casing tube and a telescopic drive having a spindle nut, a telescopic spindle which is fastened to the inner casing tube via a crash element, and a telescopic motor having a step-down gear mechanism, wherein the crash element is of at least partially hollow configuration and accommodates the spindle nut.

2. The apparatus as claimed in claim 1, wherein the crash element is formed by a sleeve and a pin which is positioned coaxially with respect to the sleeve, is at least partially inserted into the sleeve at one end side of the sleeve and is fastened to the sleeve.

3. The apparatus as claimed in claim 1, wherein the telescopic spindle is connected via a flexible drive shaft to an output shaft of the step-down gear mechanism, the opposite side of the telescopic spindle from the spindle nut being mounted rotatably in a bearing block which is structurally separate from the step-down gear mechanism.

4. The apparatus as claimed in claim 1, wherein the tensile and compressive forces which are produced during telescoping of the inner casing tube in the direction of a longitudinal axis of the telescopic spindle are passed directly from the telescopic spindle to a part of the vehicle body via the bearing block.

5. The apparatus as claimed in claim 1, wherein the outer casing tube can be pivoted about a y-axis by a pivot drive which has a spindle nut, a spindle and a flexible drive shaft, the spindle being connected via the flexible drive shaft to an output shaft of a step-down gear mechanism, and the opposite side of the spindle from the spindle nut being mounted rotatably in a bearing block which is structurally separate from the step-down gear mechanism.

6. The apparatus as claimed in claim 5, wherein the longitudinal axis and the rotational axis of the output shaft of the step-down gear mechanism, which output shaft is connected directly to the flexible drive shaft, enclose an angle between 135° and 180°.

7. The apparatus as claimed in claim 5, wherein the tensile and compressive forces which are produced during pivoting of the outer casing tube in the direction of a longitudinal axis of the spindle are passed directly from the spindle to a part of the vehicle body via the bearing block.

8. The apparatus as claimed in claim 5, wherein the spindle nut which engages with the telescopic spindle or with the spindle and the flexible drive shaft which is connected to the telescopic spindle or the spindle are formed at least partially from plastic.

9. The apparatus as claimed in claim 5, wherein the flexible drive shaft is mounted in the bearing block in a manner which is connected on the output side to the telescopic spindle or to the spindle, and is mounted in the step-down gear mechanism in a manner which is connected on the input side to the output shaft.

10. The apparatus as claimed in claim 1, wherein the step-down gear mechanism and/or the motor are/is mounted on the vehicle body by a bearing which is formed at least partially from plastic.

11. A steering-column assembly for a motor vehicle, comprising:
an outer casing tube;
a telescopic inner casing tube;
a crash element; and
a telescopic drive including
a spindle nut,
a telescopic spindle which is fastened to the inner casing tube via the crash element, and
a telescopic motor having a step-down gear mechanism, wherein the crash element is of at least partially hollow configuration and accommodates the spindle nut.

12. The apparatus as claimed in claim 11, wherein the crash element includes a sleeve and a pin, and wherein the pin is positioned coaxially with respect to the sleeve, is at least partially inserted into the sleeve at one end side of the sleeve and is fastened to the sleeve.

13. The apparatus as claimed in claim 11, further comprising a bearing block, wherein the telescopic drive includes a flexible drive shaft, wherein the telescopic spindle is connected via the flexible drive shaft to an output shaft of the step-down gear mechanism, and wherein an opposite side of the telescopic spindle from the spindle nut is mounted rotatably in the bearing block which is structurally separate from the step-down gear mechanism.

14. The apparatus as claimed in claim 11, wherein tensile and compressive forces which are produced during telescoping of the inner casing tube in the direction of a longitudinal axis of the telescopic spindle are passed directly from the telescopic spindle to a part of the vehicle body via the bearing block.

15. The apparatus as claimed in claim 11, further comprising a pivot drive for pivoting the outer casing tube, wherein the pivot drive includes a spindle nut, a spindle and a flexible drive shaft, wherein the spindle of the pivot drive is connected via the flexible drive shaft to an output shaft of a second step-down gear mechanism, and wherein an opposite side of the spindle of the pivot drive from the spindle nut of the pivot drive is mounted rotatably in a second bearing block which is structurally separate from the second step-down gear mechanism.

16. The apparatus as claimed in claim 5, wherein the longitudinal axis and the rotational axis of the output shaft of each step-down gear mechanism, which output shaft is connected directly to the respective flexible drive shaft, form an angle between 135° and 180°.

17. The apparatus as claimed in claim 5, wherein the tensile and compressive forces which are produced during pivoting of the outer casing tube in the direction of a longitudinal axis of the spindle of the pivot drive are passed directly from the spindle of the pivot drive to a part of the vehicle body via the bearing block of the pivot drive.

18. The apparatus as claimed in claim 5, wherein each spindle nut which engages with the telescopic spindle or with the spindle of the pivot drive and each flexible drive shaft which is connected to the telescopic spindle or the spindle of telescopic of the pivot drive are formed at least partially from plastic.

19. The apparatus as claimed in claim 5, wherein each flexible drive shaft is mounted in the respective bearing block in a manner which is connected on the output side to the telescopic spindle or to the spindle of the pivot drive, and is mounted in the respective step-down gear mechanism in a manner which is connected on the input side to the output shaft.

20. The apparatus as claimed in claim 5, wherein each step-down gear mechanism and/or each motor are/is mounted on the vehicle body by a bearing which is formed at least partially from plastic.
